(19) United States
(12) Patent Application Publication
(10) Pub. No.: US 2014/0182550 A1
(43) Pub. Date: Jul. 3, 2014

(54) Quill with Integrated Flow Limiter

(71) Applicant: CATERPILLAR INC., Peoria, IL (US)

(72) Inventor: Michael D. Gerstner, Peoria, IL (US)

(73) Assignee: Caterpillar Inc., Peoria, IL (US)

(21) Appl. No.: 13/731,950

(22) Filed: Dec. 31, 2012

(51) Int. Cl. F02M 61/18

(52) U.S. Cl. CPC F02M 61/18
USPC 123/445

(57) ABSTRACT

A high-pressure quill for a fuel injection system of an engine includes a pair of elongated components linked together in fluid communication. The upstream component includes a plenum chamber with a seat at its upstream end. The pair of elongated components is linked together by a linking component in a manner to permit fluid flow therethrough. A fuel flow limiter is slidably supported in the chamber and is operable during normal operation to provide predetermined quantities of fuel during each injection event to a combustion chamber and, in the event of a failure condition, to terminate fuel flow.

### TECHNICAL FIELD

The present disclosure generally relates to fuel injection systems with a common fuel rail and, in particular, to high pressure systems including a connector with an integrated flow limiter.

### BACKGROUND

Many diesel engines utilize a common rail fuel system where a common rail supplies high-pressure fuel to associated fuel injectors via branch passages that typically extend through the engine head. These branch passages typically include a specialized pipe, which is often referred to as a quill. The quill may include a rounded end received by a conical seat of the high-pressure fuel inlet port of the fuel injector and another high-pressure fitting connection or seat at its opposite end to connect to the common rail. As such, each quill serves to deliver high-pressure fuel from the common rail into a corresponding fuel injector.

Known high pressure fuel injection systems frequently employ flow limiters configured to provide desired or predetermined amounts of fuel from the common rail, through the quill, and into a corresponding fuel injector for each injection cycle. Flow limiters also may serve to completely interrupt fuel flow from the common rail into an injector when a given injector fails so as to protect engines from overfueling. Typically, flow limiters interrupt flow when the injected quantity of fuel is determined to be in excess of a predetermined acceptable or normal amount. The injector itself generally controls the injected quantity of fuel.

A typical flow limiter only interrupts fuel flow if an error condition is sensed such as when an injector fails to stop injecting fuel. Commonly flow limiters are disposed between the common rail and the quills. Additionally, quills and flow limiters are usually distinct and separate components of a fuel injection system. Although widely used for larger engines because of associated increased costs with engine failures due to overfueling, it is less common for smaller engines to use flow limiters both because of lesser costs associated with overfueling as well as space constraints within a smaller engine.

Although high pressure injection systems using high pressure quills and separate flow limiters have generally worked as intended, there remains a continual need to reduce the number of fuel injector system components and to simplify component design and to make more efficient use of available space. There have been attempts in the past to include a flow limiter within a high-pressure connector or quill. U.S. Pat. No. 6,840,268 by Kennedy et al. describes a fuel injection system that uses a one-piece high-pressure connector having a fuel flow limiter disposed within the fuel passage. In the Kennedy reference, because the high-pressure connector is a one-piece elongated component that extends from the common rail into a corresponding injector, if there is a failure of any subcomponent of the connector it is unnecessarily cumbersome to access and replace a subcomponent connector part. As such, if one subcomponent part becomes inoperative, it would possibly necessitate a replacement of an entire connector and flow limiter combination.

Additionally, in the Kennedy reference, the end of the fuel flow limiter that is proximate to the common rail is a flush surface having sharp internal corners which have the capability of adding additional stress inside the high-pressure bore which in turn may lead to premature component failure. Also, in at least one embodiment of the Kennedy reference, the flow limiter is disposed downstream of the edge filter such that any debris generated by the flow limiter would not be screened out by the filter. The Kennedy device also utilizes a pressed-in retainer bushing to seal extremely high-pressure fluid using only the outward force exerted by the pressed-in bushing which would make it susceptible to displacement or movement.

### SUMMARY OF THE INVENTION

In one aspect, a high-pressure connector or quill for a fuel injection system of an internal combustion engine includes a pair of elongated components linked together in fluid communication. The upstream elongated component includes a plenum chamber with an angled seat at its upstream end. The pair of elongated components is linked together by a linking component in a manner to permit fluid flow therethrough. A fuel flow limiter is slidably supported in the plenum chamber and includes a main body having a tapered end configured to be releasably received in the angled seat of the upstream end of the plenum chamber.

In another aspect, a fuel injection system for an internal combustion engine includes a high-pressure fuel source and fuel injectors operative in the engine to provide quantities of fuel into the combustion chambers. The fuel injection system also includes a number of high-pressure quills and corresponding fuel flow limiters as described above.

In a further aspect, an internal combustion engine includes an engine block with a number of cylinders with corresponding pistons. The pistons are each reciprocally supported in one of the cylinders. Each piston and cylinder combination defines a combustion chamber. The engine also includes a cylinder head mounted to the engine block. The engine also includes the fuel injection system, the high-pressure quills, and the fuel flow limiters as described above.

### BRIEF DESCRIPTION OF THE DRAWINGS

FIG. 1 is a cross-sectional side view of the high-pressure quill according to the present disclosure showing the fuel flow limiter in a starting position;

FIG. 2 is a cross-sectional side view of the high-pressure quill according to the present disclosure showing the fuel flow limiter in an operative position;

FIG. 3 is a cross-sectional side view of the high-pressure quill according to the present disclosure showing the fuel flow limiter in a closed position;

FIG. 4 is a partial perspective view of the fuel injection system of the present disclosure showing the high-pressure quill in fluid communication with a fuel injector;

FIG. 5 is a partial perspective view of the fuel injection system of the present disclosure showing the high-pressure quill in fluid communication with a fuel injector and the common fuel rail; and

FIG. 6 is a schematic: view of an exemplary internal combustion engine showing the fuel injection system and the high pressure quill of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

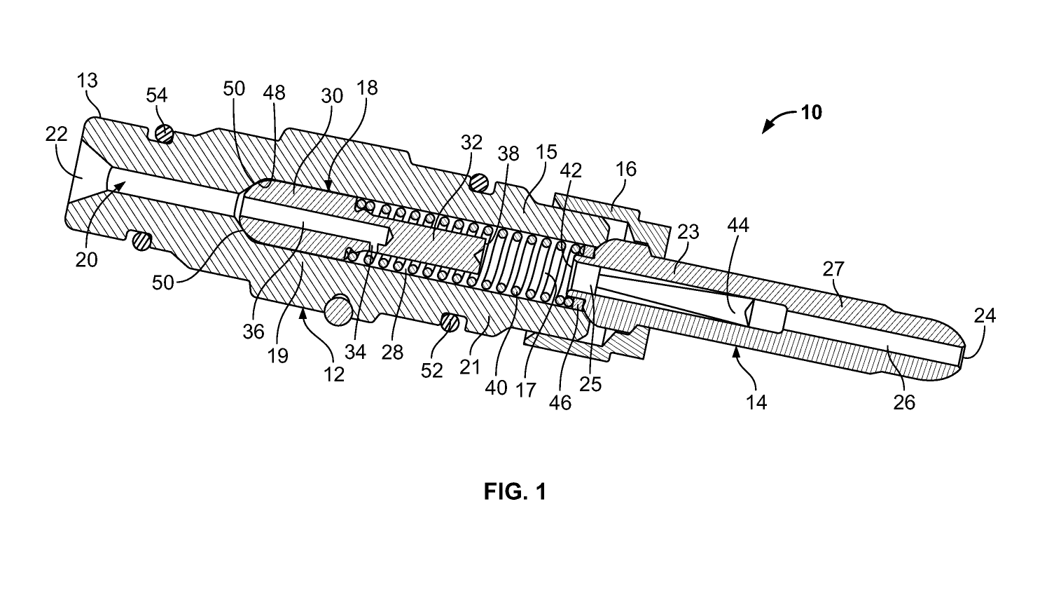

Many diesel engines may utilize a common rail fuel system where the common rail may supply high-pressure fuel to associated fuel injectors via branch passages that may extend through an engine head. These branch passages may include a specialized pipe, which is often referred to as a quill. A quill may be operative to deliver high-pressure fuel from the common rail into a corresponding fuel injector. With reference to FIG. 1, a high-pressure connector or will of the present disclosure, generally indicated at 10, may include a first elongated component 12. The first elongated component 10 may include a first end 13 that may be disposed upstream with respect to fuel flow through the quill 10. The first end 13 of the first elongated component may include a fuel inlet 22 that may be in fluid communication with a high-pressure fuel source.

The second end 15 of the first elongated component, generally disposed downstream with respect to fluid flow, may include a fuel outlet 17 where the fuel may exit the first elongated component 12. A fuel passage 20 may extend through the first elongated component 12 from the fuel inlet 22 to the fuel outlet 17.

The fuel passage 20 may in part define a high-pressure bore or plenum chamber 28. The plenum chamber 28 may have an upstream end 19. The upstream end 19 of the plenum chamber 28 may include a seat 50 that may be configured to receive a fuel flow limiter 18 as will be described in greater detail herein. The seat 50 may be angled, curved, or otherwise configured as appropriate to receive the fuel flow limiter 18. For illustrative purposes, the seat 50 is shown and described in the present disclosure as an angled seat 50. The plenum chamber 28 may also include a downstream end 21 that may include the fuel outlet 17 of the first elongated component 12.

The high pressure quill 10 may include a second elongated component 14 that may include a first end 23 that may include a fuel inlet 25 that may be in fluid communication with the fuel passage 20 and the plenum chamber 28 of the first elongated component 12. The second elongated component 12 may include a second end 27 that may include a fuel outlet 24. The second elongated component 12 may also include an outlet fuel passage 26 extending through the second elongated component 14 from the fuel inlet 25 to the fuel outlet 24.

In order to link the first and second elongated components 12, 14 together, the first end 23 of the second elongated component 14 may be at least partially received within the second end 15 of the first elongated component 12 such that the fuel passage 20 of the first elongated component 12 and the outlet fuel passage 26 of the second elongated component 14 may be in fluid communication. A washer 46 may be disposed between the first end 23 of the second elongated component 14 and the second end 15 of the first elongated component 12 so as to form a seat for the spring 40. External seals 52, 54 may be disposed in corresponding annular grooves formed about the outer periphery of the high-pressure quill 10 to effect an air-tight seal between the quill 10 and a cylinder head 66 mounted on an engine block of an internal combustion engine.

A seal may be formed between the first and second components 12, 14 where they abut. The first end 23 of the second component 14 may be partially curved where it abuts the second end 15 of the first component 12. This arrangement may allow the second component 14 to slightly move or rotate relative to the first component 12 during assembly which may allow for easier fitting and aligning of the components. In other words, during assembly the components 12, 14 may slightly “bend” where they abut without losing the seal therebetween.

The high-pressure quill 10 may include a linking component 16 that may be at least partially disposed about the second end 15 of the first elongated component 12 and the first end 23 of the second elongated component 14 such that the first and second elongated components 12,14 may be fixedly connected in a manner to permit fluid communication between them. Alternatively, corresponding threads may be machined into components 12, 14.

As mentioned previously, a fuel flow limiter 18 may be slidably supported in the plenum chamber 28 of the fuel passage 20 of the first elongated component 12. The fuel flow limiter 18 may include a main body 30. The main body 30 may have a tapered end portion 48 configured to be releasably received in the angled seat 50 of the upstream end 19 of the plenum chamber 28.

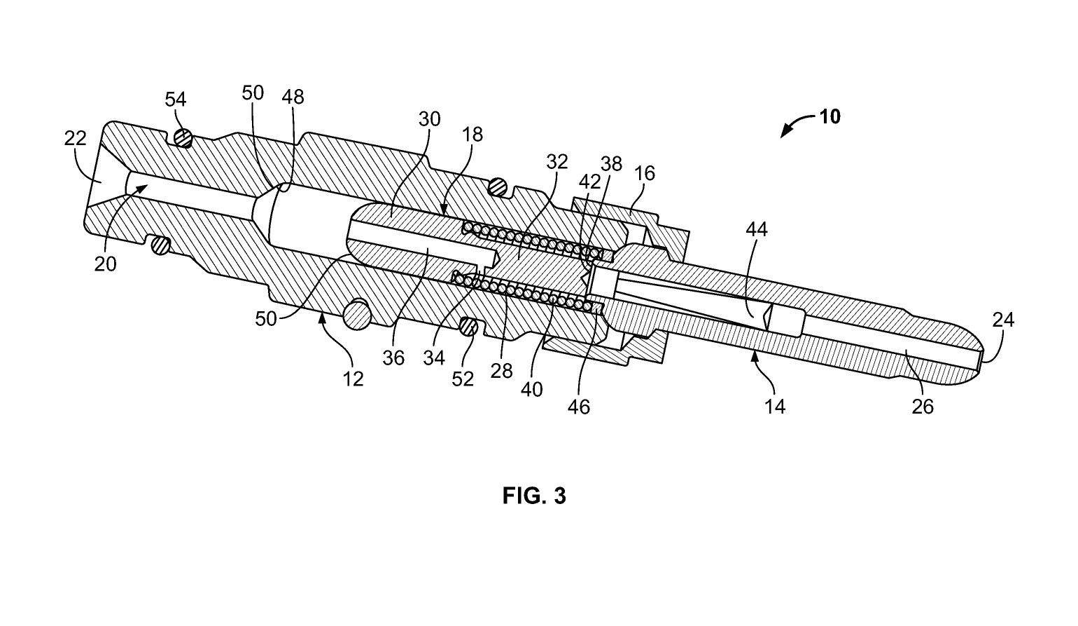

The fuel flow limiter 18 may further include a high-pressure flow path 36 that may further form a part of the fuel passage 20. The high-pressure flow path 36 may include at least one fuel opening 34 that may disperse fuel into the plenum chamber 18. The fuel flow limiter 18 may further include an end portion 32 that may extend downstream from the main body 30. The end portion 32 may be of a smaller diameter than the main body 30. The end portion 32 may further include a stop valve 38 that may be substantially planar. The first end 23 of the second elongated component 14 may include a stop valve seat 42 that may also be substantially planar and may be configured to selectively receive the stop valve 38 of the fuel flow limiter 18 as shown in FIG. 3 where it is shown in a closed position that may halt and prevent fuel flow through the outlet fuel passage 26 upon the occurrence of a malfunction or failure in a combustion chamber or injector.

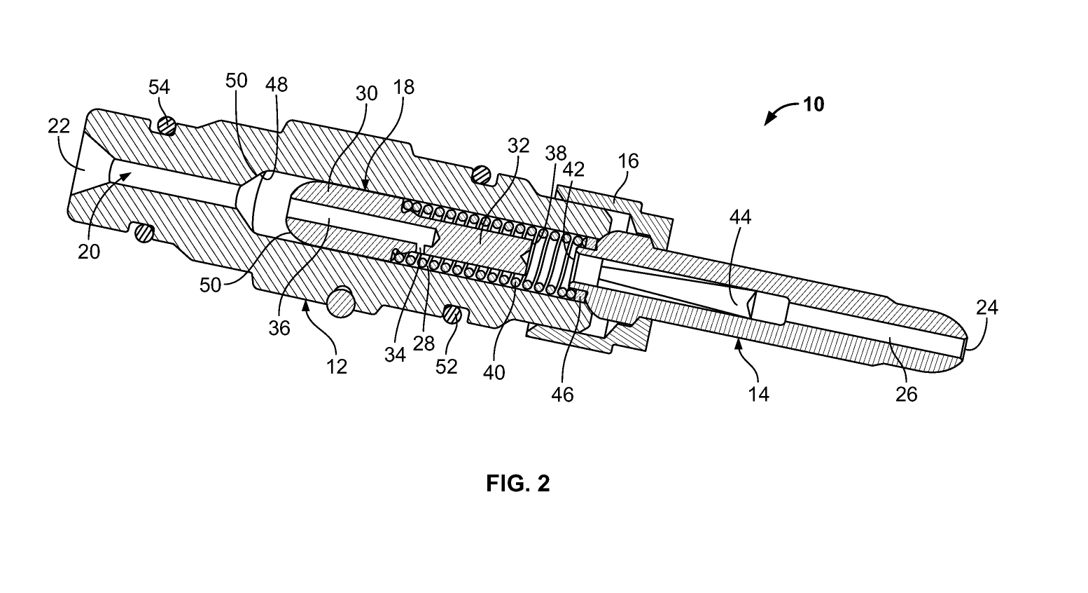

The tapered end portion 48 of the main body 30 of the fuel flow limiter 18 may be substantially frustoconically shaped. The angled seat 50 of the plenum chamber 28 may also be substantially frustoconically shaped so that the tapered end portion 48 of the main body 30 of the fuel flow limiter 18 may be received within the angled seat 50 of the plenum chamber when the fuel flow limiter 18 is in a starting position as shown in FIG. 1. In this starting position, high pressure fuel may be collected within the plenum chamber 28. As shown in FIG. 2, the fuel flow limiter 18 may be moved downstream from the starting position into an operative position where a quantity of high pressure fuel may be supplied from the plenum chamber 28 through the fuel outlet 17 of the first elongated component 12, into the fuel inlet 25 of the second elongated component 14, through the outlet fuel passage 26, and out the fuel outlet 24 of the second elongated component 14.

A biasing member 40, which may be a spring as shown in the Figures, may be supported within the plenum chamber 28. The biasing member 40 is operable to bias the main body 30 of the fuel flow limiter 18 into the starting position as shown in FIG. 1. Additionally, an integrated filter 44 may be disposed and mounted in the outlet fuel passage 26 of the second elongated component 14.

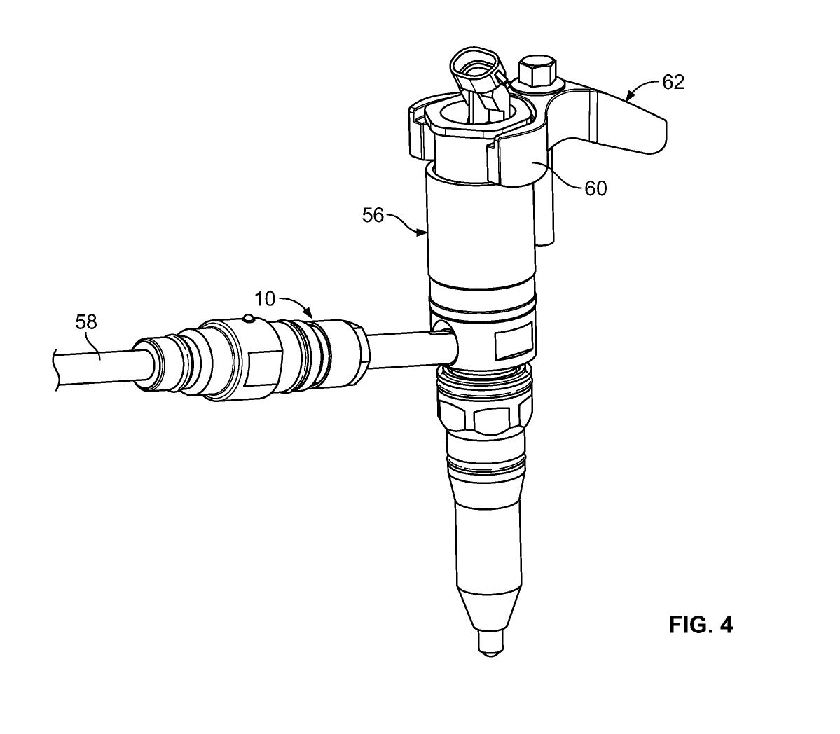

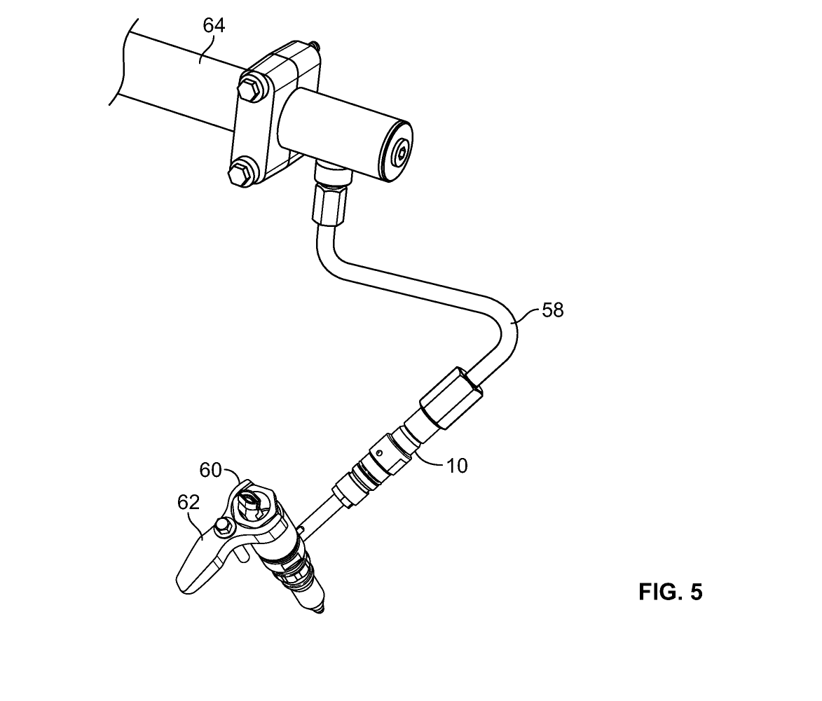

As shown in FIGS. 4-6, a fuel injection system for an internal combustion engine is shown that may utilize the above-described high-pressure quill 10. The fuel injection system 55 may have combustion chambers 67 serviced by fuel injectors 56 that may include a high-pressure fuel source 58 fed through fuel lines 76 that lead to a common fuel rail 64. The fuel injectors 56 may be operatively disposed on an internal combustion engine 68 for providing predetermined quantities of fuel into the combustion chambers 67. The fuel injector system 55 may include a fuel injector fastening system 62, including a clamp 60, for retaining each of the injectors 56 in place and in communication with a corresponding combustion chamber 67.

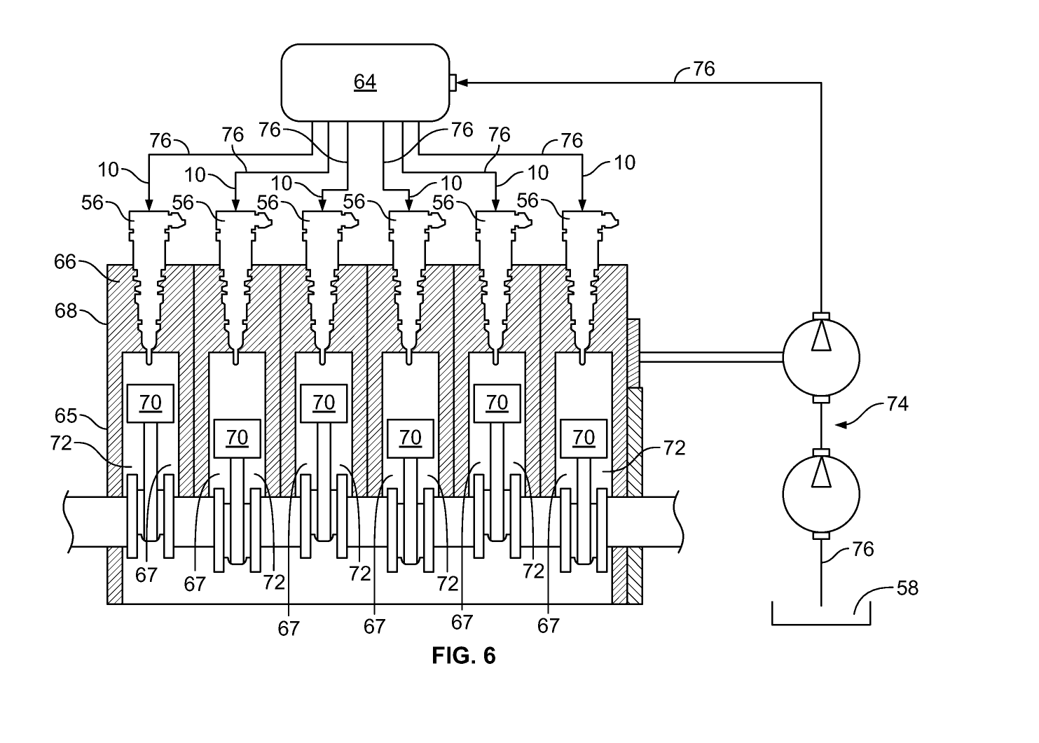

As further shown in FIG. 6, the internal combustion engine 68 utilizing the above-described high-pressure quills 10 may include an engine block 65 having a cylinder head 66 and a plurality of cylinders 72 and corresponding pistons 70 that may be reciprocally supported in each one of the plurality of cylinders 72. Each piston and cylinder combination may define a combustion chamber 67 within the engine block 65. A fuel pumping system 74 may be utilized to propel the fuel as desired from the fuel source 58, through the fuel lines 76 and through the common rail 64.

### INDUSTRIAL APPLICABILITY

The high pressure quill 10 of the present disclosure has wide application in a variety of engine types including, for example, diesel engines, gasoline engines, and gaseous fuel-powered engines. The disclosed high pressure quill 10 may be implemented into the fuel system of any engine that utilizes a high pressure fuel supply and closed orifice-type fuel injectors where fabrication time and cost are concerns, and flow limiting is desired.

The operation of the high pressure quill 10 of the present disclosure will be described in greater detail with reference to FIGS. 1-3. High pressure fuel flows through the inlet 22 and through the fuel passage 20 defined in the first elongated component 12 of the quill. As mentioned previously, a fuel flow limiter 18 may be slidably supported in the plenum chamber 28 of the fuel passage 20 of the first elongated component 12. The fuel flows into and through a high-pressure flow path 36 in the body 30 of the flow limiter 18 and out through the fuel openings 34 and into the plenum chamber 28. The interior volume of the plenum chamber 28 may be larger than a maximum volume of fuel of a single injection event. Before any injection event, the pressure in the plenum chamber 28 in combination with the biasing member 40 causes the main body 30 of the fuel flow limiter 18 to retract the starting position as shown in FIG. 1. In this initial position, the tapered end portion 48 of the main body 30 of the fuel flow limiter 18 may be received within the angled seat 50 of the plenum chamber 28.

During an injection event, fuel is drawn from the plenum chamber 28 and the pressure in the chamber is thereby reduced. The high pressure on the fuel delivery side of the quill 10 causes a force imbalance on the body 30 of the fuel flow limiter. The flow limiter body 30 then moves into an operative position as shown in FIG. 2 under the influence of this force imbalance and toward the stop valve seat 42 but not so far downstream so as to engage the stop valve 38 against the seat 42.

After the completion of each injection event, the pressure in the plenum chamber 28 equalizes with the fuel supply pressure. As such, the force of the biasing member 40 moves the flow limiter body 30 back toward the angled seat 50 to its first position shown in FIG. 1.

If an injector were to fail, pressure on the fuel output side of the flow limiter main body 30 exceeds the pressure in the plenum chamber 28 which causes the flow limiter body 30 to move down the entire length of the chamber 28 such that the stop valve seat 42 receives the stop valve 38 of the fuel flow limiter 18 as shown in FIG. 3. In this closed position, fuel flow is prevented through the outlet fuel passage 26 upon the occurrence of a malfunction or failure in a combustion chamber or injector. In general, once the flow limiter 18 closes in the event of a malfunction or failure, it may remain closed and not open or retract again until the engine is shut down and the fuel pressure drops to a minimal level. This is due to the fuel downstream of the closed valve 38 entering a corresponding cylinder 72 resulting in a very low downstream fuel pressure. Also, the fuel pressure upstream of the closed valve remains relatively higher in order to keep the engine running. As such, the valve 38 may remain closed after failure of the injector 56 until the engine is shut off.

What is claimed is:

1. A high-pressure quill for a fuel injection system of an internal combustion engine, the high-pressure quill comprising:
a first elongated component comprising a first end that includes a fuel inlet, a second end having a fuel outlet, a fuel passage extending through said first elongated component from said fuel inlet to said fuel outlet, said fuel passage at least partially defining a plenum chamber, said plenum chamber having an upstream end comprising a seat and a downstream end proximate said fuel outlet;
a second elongated component comprising a first end that includes a fuel a second end having a fuel outlet, an outlet fuel passage extending through said second elongated component from said fuel inlet to said fuel outlet, said first end of said second elongated component being at least partially received within said second end of said first elongated component such that said fuel passage of said first elongated component and said fuel passage of said second elongated component are in fluid communication;
a linking component at least partially disposed about said second end of said first elongated component and said first end of said second elongated component such that said first and second elongated components are fixedly connected in a manner to permit fluid communication therebetween; and
a fuel flow limiter slidably supported in said plenum chamber of said fuel passage of said first elongated component, said fuel flow limiter comprising a main body having a tapered end configured to be releasably received in said angled seat of said upstream end of said plenum chamber.

2. The high-pressure quill of claim 1 where said fuel flow limiter is moveable in said fuel passage of said first elongated component among:
a starting position wherein high pressure fuel is collected within said plenum chamber;
an operative position at which a quantity of high pressure fuel is supplied from said plenum chamber through said fuel outlet of said first elongated component, into said fuel inlet of said second elongated component, through the outlet fuel passage, and out said fuel outlet of said second elongated component; and
a closed position that halts and prevents fuel flow through the outlet fuel passage upon the occurrence of an injector failure event.

3. The high-pressure quill of claim 2 wherein said fuel flow limiter further includes a high-pressure flow path comprising a part of said fuel passage, said high-pressure flow path further including at least one fuel opening that disperses fuel into said plenum chamber, said seat of said upstream end of said plenum chamber further comprising an angled seat.

4. The high-pressure quill of claim 3 wherein said fuel flow limiter further includes an end portion that extends downstream from said main body, and wherein said end portion further defines a stop valve.

5. The high-pressure quill of claim 4 wherein said first end of said second elongated component further comprises a stop valve seat configured to receive said stop valve of said fuel flow limiter when said fuel flow limiter is in said closed position.

6. The high-pressure quill of claim 5 further comprising a biasing member supported within said plenum chamber and operable to bias said body of said fuel flow limiter to said starting position.

7. The high-pressure quill of claim 6 further including a seal disposed between said first end of said second elongated component and said second end of said first elongated component.

8. The high-pressure quill of claim 1 wherein said tapered end of said main body of said fuel flow limiter and said angled seat of said plenum chamber are substantially frustoconically shaped.

9. The high-pressure quill of claim 8 wherein said stop valve comprises a substantially planar surface.

10. A fuel injection system for an internal combustion engine having combustion chambers serviced by fuel injectors, said fuel injection system comprising:
A high-pressure fuel source, at least one fuel injector operatively disposed on said engine for providing quantities of fuel into the combustion chambers;
A high-pressure quill comprising a first elongated component including a first end that includes a fuel inlet, a second end having a fuel outlet, a fuel passage extending through said first elongated component from said fuel inlet to said fuel outlet, said fuel passage at least partially defining a plenum chamber, said plenum chamber having an upstream end comprising a seat and a downstream end proximate said fuel outlet, and further comprising a second elongated component comprising a first end that includes a fuel inlet, a second end having a fuel outlet, an outlet fuel passage extending through said second elongated component from said fuel inlet to said fuel outlet, said first end of said second elongated component being at least partially received within said second end of said first elongated component such that said fuel passage of said first elongated component and said fuel passage of said second elongated component are in fluid communication; and farther comprising a linking component at least partially disposed about said second end of said first elongated component and said first end of said second elongated component such that said first and second elongated components are fixedly connected in a manner to permit fluid communication therebetween; and
a fuel flow limiter slidably supported in said plenum chamber of said fuel passage of said first elongated component, said fuel flow limiter comprising a main body having a tapered end configured to be releasably received in said angled seat of said upstream end of said plenum chamber.

11. The fuel injection system of claim 10 where said fuel flow limiter is moveable in said fuel passage of said first elongated component among:
a starting position wherein high pressure fuel is collected within said plenum chamber;
an operative position at which a quantity of high pressure fuel is supplied from said plenum chamber through said fuel outlet of said first elongated component, into said fuel inlet of said second elongated component, through the outlet fuel passage, and out said fuel outlet of said second elongated component; and
a closed position that halts and prevents fuel flow through the outlet fuel passage upon the occurrence of an injector failure event.

12. The fuel injection system of claim 11 wherein said fuel flow limiter further includes a high-pressure flow path comprising a part of said fuel passage said high-pressure flow path further including at least one fuel opening that disperses fuel into said plenum chamber, said seat of said upstream end of said plenum chamber further comprising an angled seat.

13. The fuel injection system of claim 12 wherein said fuel flow limiter further includes an end portion that extends downstream from said main body, and wherein said end portion further defines a stop valve.

14. The fuel injection system of claim 13 wherein said first end of said second elongated component further comprises a stop valve seat configured to receive said stop valve of said fuel flow limiter then said fuel flow limiter is in said closed position.

15. The fuel injection system of claim 14 further comprising a biasing member supported within said plenum chamber and operable to bias said body of said fuel flow limiter to said starting position.

16. The fuel injection system of claim 15 further including a seal disposed between said first end of said second elongated component and said second end of said first elongated component.

17. The fuel injection system of claim 10 wherein said tapered end of said main body of said fuel flow limiter and said angled seat of said plenum chamber are substantially frustoconically shaped.

18. The fuel injection system of claim 14 wherein said stop valve comprises a substantially planar surface.

19. An internal combustion engine comprising:
an engine block including a plurality of cylinders having corresponding pistons reciprocally supported in each one of said plurality of cylinders so as to define a plurality of combustion chambers within said engine block, and a cylinder head mounted to said engine block;
a fuel injection system for providing high-pressure fuel to said combustion chambers, said fuel injection system comprising a high-pressure fuel source, and at least one fuel injector operatively disposed on said engine for providing quantities of fuel into the combustion chambers;
a high-pressure quill comprising a first elongated component including a first end that includes a fuel inlet, a second end having a fuel outlet, a fuel passage extending through said first elongated component from said fuel inlet to said fuel outlet, said fuel passage at least partially defining a plenum chamber, said plenum chamber having an upstream end comprising a seat and a downstream end proximate said fuel outlet, and further comprising a second elongated component comprising a first end that includes a fuel inlet, a second end having a fuel outlet, an outlet fuel passage extending through said second elongated component from said fuel inlet to said fuel outlet, said first end of said second elongated component being at least partially received within said second end of said first elongated component such that said fuel passage of said first elongated component and said fuel passage of said second elongated component are in fluid communication; and further comprising a linking component at least partially disposed about said second end of said first elongated component and said first end of said second elongated component such that said first and second elongated components are fixedly connected in a manner to permit fluid communication therebetween; and
a fuel flow limiter slidably supported in said plenum chamber of said fuel passage of said first elongated component, said fuel flow limiter comprising a main body having a tapered end configured to be releasably received in said angled seat of said upstream end of said plenum chamber.

20. The internal combustion engine of claim 19, wherein said fuel flow limiter is moveable in said fuel passage of said first elongated component among a starting position wherein high pressure fuel is collected within said plenum chamber, an operative position at which a quantity of high pressure fuel is supplied from said plenum chamber through said fuel outlet of said first elongated component, into said fuel inlet of said second elongated component, through the outlet fuel passage, and out said fuel outlet of said second elongated component, and a closed position that halts and prevents fuel flow through the outlet fuel passage upon the occurrence of an injector failure event; said first end of said second elongated component further comprising a stop valve seat configured to receive said stop valve of said fuel flow limiter when said fuel flow limiter is in said closed position; wherein said tapered end of said main body of said fuel flow limiter is substantially frustoconically shaped; wherein said seat of said upstream end of said plenum chamber further comprises an angled seat; and wherein said stop valve comprises a substantially planar surface.
